(19) United States
(12) Patent Application Publication
(10) Pub. No.: US 2011/0142331 A1
(43) Pub. Date: Jun. 16, 2011

(54) SYSTEM AND METHOD OF COLOR INTERPOLATION

(75) Inventor: TAI-HUNG CHEN, Taipei (TW)

(73) Assignee: ABILITY ENTERPRISE CO., LTD., TAIPEI (TW)

(21) Appl. No.: 12/685,210

(22) Filed: Jan. 11, 2010

(30) Foreign Application Priority Data
Dec. 15, 2009 (TW) 098142971

(51) Int. Cl. G06K 9/00

(52) U.S. Cl. 382/162; 382/300; 382/263; 382/279

(57) ABSTRACT

A system and method of color interpolation includes a spatial convolution unit that receives an output of an image sensor and then performs spatial convolution on the received image-sensor output, thus generating a convolution signal. A color interpolation unit performs color interpolation on the convolution signal, thus generating a color-interpolated signal. Finally, a spatial deconvolution unit performs spatial deconvolution, which is the inverse of the spatial convolution, on the color-interpolated signal, thus generating a preprocessed image.

### CROSS-REFERENCE TO RELATED APPLICATIONS

This application claims the right of priority based on Taiwan Patent Application No. 098142971, filed Dec. 15, 2009, the entire contents of which are hereby incorporated by reference.

### BACKGROUND OF THE INVENTION

1. Field of the Invention

The present invention generally relates to digital image processing, and more particularly to a color interpolation method of image preprocessing.

2. Description of Related Art

An imaging device such as a digital camera or a video camcorder uses an image sensor (e.g., charge coupled device (CCD) or complementary metal oxide semiconductor (CMOS) image sensor) to convert an optical image to electrical signals. As each photosensor of the image sensor usually captures only one of the colors, the output signals from an entire photosensor array therefore cannot be comprehended by a user's eyes as a normal picture. A color interpolation technique is thus commonly utilized to convert the output signals to image signals; this is ordinarily known as image preprocessing.

There are a variety of color interpolation methods used in the image preprocessing arena. Some methods are simple but have reduced resolution and contrast, and can generate image noise. Other methods, even to the extent able to maintain resolution and image quality, nonetheless suffer from other drawbacks such as complicated algorithms and increased latency or circuit area.

A need has thus arisen to propose a novel system or method of color interpolation with simplified structure and algorithm for better image quality.

### SUMMARY OF THE INVENTION

The embodiments of the present invention disclose a system and method of color interpolation with simplified structure and algorithm. The disclosed system and method may effectively maintain image resolution, reduce error percentage of color interpolation and improve image quality, particularly the image quality on the image edge.

According to one embodiment of the present invention, the color interpolation system includes a spatial convolution unit, a color interpolation unit and a spatial deconvolution unit. The spatial convolution unit may comprise a high-pass filter with standard deviations as coefficients, and may receive an output of an image sensor and perform spatial convolution on the received image-sensor output, thereby generating a convolution signal. The color interpolation unit may perform color interpolation on the convolution signal, thereby generating a color-interpolated signal. The spatial deconvolution unit may perform spatial deconvolution, which is the inverse of the spatial convolution, on the color-interpolated signal, thereby generating a preprocessed image.

### BRIEF DESCRIPTION OF THE DRAWINGS

FIG. 1 is a schematic diagram of a photosensor array of an image sensor covered with a color filter array;

FIG. 2 is a block diagram depicting a color interpolation system according to one embodiment of the present invention;

FIG. 3 is a flow diagram illustrating a color interpolation method according to the embodiment of the present invention; and

FIG. 4 shows an exemplary Bayer pattern.

### DETAILED DESCRIPTION OF THE INVENTION

Color interpolation according to embodiments of the present invention comprises one of multiple categories of digital image processing. Particularly, the color interpolation can be or be a part of image preprocessing, which reconstructs color sampled outputs of an image sensor (e.g., a CCD or CMOS image sensor) into a color picture. FIG. 1 is a schematic diagram of a photosensor array 10 of an image sensor covered with a color filter array (CFA) 12. Each color filter (CF) of the color filter array 12 passes light of only one color that is then sensed by a corresponding photosensor. As the specific mosaic pattern of the color filter array 12 cannot be comprehended by human eyes, color interpolation is needed to reconstruct the image-sensor output into a picture comprehensible by people. Accordingly, this reconstruction or color interpolation is sometimes referred to as CFA interpolation, color reconstruction or demosaicking. The color filter array 12 exemplified in FIG. 1 is a Bayer filter which commonly may be used in a digital camera or digital camcorder. The red (R), green (G) and blue (B) filters of the Bayer filter may be arranged as shown in the figure, in which the pattern is 50% green, 25% red and 25% blue. The other colors at each pixel may be obtained according to neighboring pixels. For example, the red value at a green pixel (G) may be obtained based on adjacent top and bottom red pixels (R) or based on adjacent right and left red pixels (R), and the blue value at a green pixel (G) may be obtained based on adjacent right and left blue pixels (B) or based on adjacent top and bottom blue pixels (B). As another example, the green value at a red pixel (R) may be obtained based on adjacent top, bottom, right and left green pixels (G), and a blue value at the red pixel (R) may be obtained based on adjacent top right, top left, bottom right and bottom left blue pixels (B).

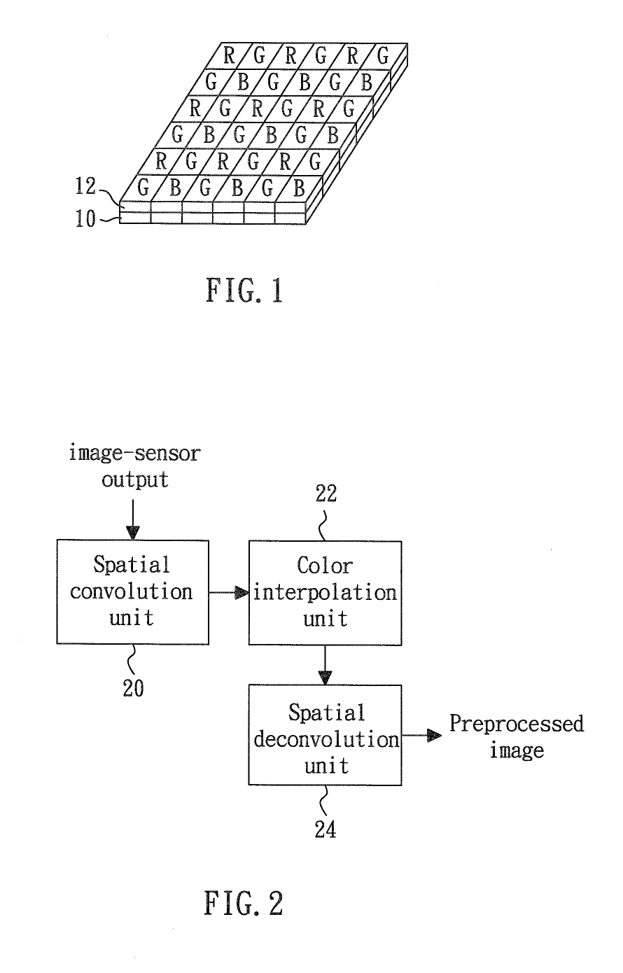

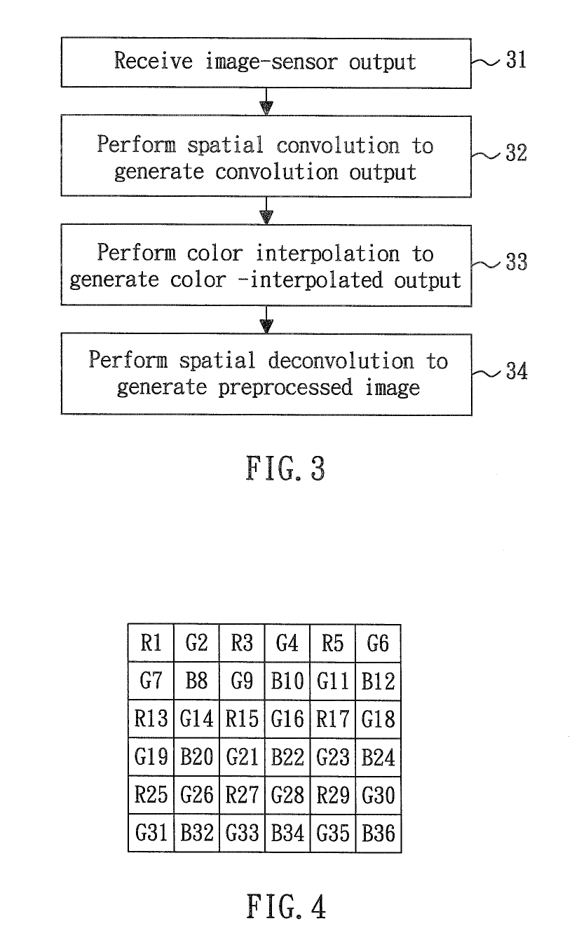

FIG. 2 is a schematic block diagram illustrating a color interpolation system according to one embodiment of the present invention, and FIG. 3 is a flow diagram elucidating a color interpolation method according to the embodiment of the present invention. The illustrated embodiment may be adapted to any of a variety of imaging devices such as digital cameras or digital camcorders. The image sensor utilized in the present embodiment may comprise one or more of a variety of image sensors such as CCDs or CMOS image sensors. Further, the color filter array utilized in the present embodiment may be, but is not limited to, the Bayer filter exemplified in FIG. 1.

In the illustrated embodiment, the color interpolation system FIG. 2 primarily includes a spatial convolution unit 20, a color interpolation unit 22 and a spatial deconvolution unit 24. Specifically, the spatial convolution unit 20 receives an output from an image sensor (e.g., the output conformed to a Bayer pattern as shown in FIG. 1) at step 31, and then performs spatial convolution on the image-sensor output at step 32, thereby generating a convolution output or signal. In the embodiment, the spatial convolution unit 20 may be a spatial filter such as a high-pass filter. The high-pass filter passes high-frequency components but attenuates other components. As embodied herein, the high-pass spatial filtering typically utilizes a high-pass filter matrix or a mask to operate on each pixel and its neighbors, with matrix coefficients as weightings. In a preferred embodiment, the matrix coefficients are derived from standard deviations of the image-sensor output. Accordingly, the convolution signal from the spatial convolution unit 20 mainly includes edge information.

Subsequently, the color interpolation unit 22 of the embodiment performs color interpolation on the convolution signal at step 33, thereby generating a color-interpolated output or signal. In the embodiment, the color interpolation unit 22 may utilize conventional color interpolation methods or algorithms. Such conventional color interpolation methods may be mainly classified into two types: non-adaptive and adaptive. The non-adaptive color interpolation method is globally performed on all pixels using the same algorithm, while the adaptive color interpolation method is adaptively performed on each pixel according to its local trend. Details on a variety of known non-adaptive and adaptive color interpolation methods may be obtained, for example, from the following web page: http://scien.stanford.edu/class/psych221/projects/99/tingchen/main.htm, the disclosure of which is hereby incorporated by reference.

Bilinear interpolation is one of the commonly used non-adaptive color interpolation methods. Other non-adaptive color interpolation methods can comprise, for example, nearest neighbor replication and cubic convolution. With respect to the bilinear interpolation method, a green value may be obtained as the average of adjacent top, bottom, left and right green pixels (G). FIG. 4 shows an exemplary Bayer pattern, according to which G15=(G9+G21+G14+G16)/4. The red value at a green pixel (G) may be obtained as the average of adjacent top and bottom red pixels (R) or the average of adjacent left and right red pixels (R), whereby, for example, R9=(R3+R15)/2 in FIG. 4. The blue value at a green pixel (G) may be obtained as the average of adjacent left and right blue pixels (B) or the average of adjacent top and bottom blue pixels (B), whereby, for example, B9=(B8+B10)/2 in FIG. 4. The red value at a blue pixel (B) may be obtained as the average of adjacent top right, bottom right, bottom left and top left red pixels (R), whereby, for example, R20=(R15+R27+R25+R13)/4 in FIG. 4. The blue value at a red pixel (R) may be obtained as the average of adjacent top right, bottom right, bottom left and top left blue pixels (B), whereby, for example, B15=(B10+B22+B20+B8)/4 in FIG. 4.

Edge sensing interpolation is one of the commonly used adaptive color interpolation methods. Other adaptive color interpolation methods can comprise, for example, interpolation with color correction and variable number gradients. With respect to the edge sensing interpolation method, a green value is obtained as the average of adjacent pixels along the direction with less gradient. For example, regarding the B8 pixel in FIG. 4, if its horizontal gradient (e.g., an absolute value of the difference between G7 and G9) is less than a threshold, and its vertical gradient (e.g., an absolute value of the difference between G2 and G14) is greater than the threshold, then G8=(G7+G9)/2. The red value and the blue value may be obtained using algorithms of other interpolation methods.

It is noted that, although the color interpolation unit 22 of the present embodiment may use a conventional color interpolation technique, the present embodiment, nevertheless, is distinct from conventional systems/methods with at least the following significant difference. The color interpolation unit 22 of the present embodiment performs color interpolation on the convolution output or signal, such as the high-pass filtered edge information (from the spatial convolution unit 20). On the contrary, the conventional systems/methods perform color interpolation directly on the image-sensor outputs. Accordingly, the present embodiment may thus substantially enhance the color-interpolated results. In other words, the present embodiment may utilize a simpler color interpolation algorithm (e.g., a non-adaptive color interpolation algorithm) in order to arrive at an effectiveness corresponding to (e.g., the same effectiveness as) that of conventional systems/methods which utilize more complicated color interpolation algorithms.

In the embodiment, finally, the spatial deconvolution unit 24 performs spatial deconvolution on the color-interpolated signal at step 34, thereby generating a preprocessed image, where the spatial deconvolution is the inverse of the spatial convolution (of the spatial convolution unit 20). In the embodiment, the spatial deconvolution may be an inverse matrix of the high-pass filter matrix mentioned above. The inverse matrix is then used as a mask to operate on each pixel and its neighbors, with matrix coefficients as weightings.

Although specific embodiments have been illustrated and described, it will be appreciated by those skilled in the art that various modifications may be made without departing from the scope of the present invention, which is intended to be limited solely by the appended claims.

What is claimed is:

1. A color interpolation system, comprising:
a spatial convolution unit having a configuration to enable performance of spatial convolution on an image-sensor output, and having an output to provide a generated convolution signal;
a color interpolation unit with an arrangement to receive and perform color interpolation on the convolution signal, and with an output to provide a generated color-interpolated signal; and
a spatial deconvolution unit coupled to receive and configured to perform spatial deconvolution on the color-interpolated signal, thereby generating a preprocessed image, wherein the spatial deconvolution is an inverse operation of the spatial convolution.

2. The system of claim 1, wherein the spatial convolution unit comprises a spatial filter.

3. The system of claim 2, wherein the spatial filter is a high-pass filter.

4. The system of claim 3, wherein the high-pass filter is a high-pass filter matrix with coefficients derived from standard deviations of the image-sensor output.

5. The system of claim 4, wherein the spatial deconvolution unit comprises an inverse matrix of the high-pass filter matrix.

6. The system of claim 1, wherein the color interpolation unit comprises non-adaptive color interpolation, which is globally performed on all pixels by way of a same operation.

7. The system of claim 6, wherein the non-adaptive color interpolation is bilinear interpolation.

8. The system of claim 1, wherein the color interpolation unit comprises adaptive color interpolation, which is adaptively performed on each pixel according to a local trend of the pixel.

9. The system of claim 8, wherein the adaptive color interpolation is edge sensing interpolation.

10. The system of claim 1, wherein the image sensor comprises a Bayer color filter array such that the image-sensor output conforms to a Bayer pattern.

11. A color interpolation method, comprising:
receiving an output of an image sensor and performing spatial convolution on the received image-sensor output, thereby generating a convolution signal;
performing color interpolation on the convolution signal, thereby generating a color-interpolated signal; and
performing spatial deconvolution on the color-interpolated signal, thereby generating a preprocessed image, wherein the spatial deconvolution is an inverse operation of the spatial convolution.

12. The method of claim 11, wherein the spatial convolution is performed by a spatial filter.

13. The method of claim 12, wherein the spatial convolution is performed by a spatial filter in the form of a high-pass filter.

14. The method of claim 13, wherein the high-pass filter is a high-pass filter matrix with coefficients derived from standard deviations of the image-sensor output.

15. The method of claim 14, wherein the spatial deconvolution is performed by an inverse matrix of the high-pass filter matrix.

16. The method of claim 11, wherein the color interpolation is non-adaptive color interpolation, which globally performs on all pixels with same operation.

17. The method of claim 16, wherein the non-adaptive color interpolation is bilinear interpolation.

18. The method of claim 11, wherein the color interpolation is adaptive color interpolation, which is adaptively performed on each pixel according to a local trend of the pixel.

19. The method of claim 18, wherein the adaptive color interpolation is edge sensing interpolation.

20. The method of claim 11, wherein the image sensor comprises a Bayer color filter array such that the image-sensor output conforms to a Bayer pattern.
